(19) United States
(12) Patent Application Publication
(10) Pub. No.: US 2020/0387357 A1
(43) Pub. Date: Dec. 10, 2020

(54) MACHINE GENERATED AUTOMATION CODE FOR SOFTWARE DEVELOPMENT AND INFRASTRUCTURE OPERATIONS

(71) Applicant: AGILE STACKS INC., San Mateo, CA (US)

(72) Inventors: John MATHON, San Mateo, CA (US); Igor MAMESHIN, Carlsbad, CA (US); Antons KRANGA, Riga (LV)

(21) Appl. No.: 16/770,261

(22) PCT Filed: Dec. 5, 2018
(86) PCT No.: PCT/US2018/064078

§ 371 Date: Jun. 5, 2020

Related U.S. Application Data
(60) Provisional application No. 62/594,947, filed on Dec. 5, 2017.

(51) Int. Cl. G06F 8/33; G06F 3/0482; G06F 9/4401; G06F 9/50

(52) U.S. Cl. CPC G06F 8/33; G06F 3/0482; G06F 2209/5011; G06F 9/5077; G06F 9/4411

(57) ABSTRACT

Techniques, systems, and devices are disclosed for implementing a system that uses machine generated infrastructure code for software development and infrastructure operations, allowing automated deployment and maintenance of a complete set of infrastructure components. One example system includes a user interface and a management platform in communication with the user interface. The user interface is configured to allow a user to deploy components for a complete web system using a set of infrastructure code such that the components are automatically configured and integrated to form the complete web system on one or more network targets.

### CROSS-REFERENCE TO RELATED APPLICATION

This patent document claims priority to U.S. provisional patent application No. 62/594,947, filed on Dec. 5, 2017, which is in incorporated herein by reference in its entirety for all purposes.

### TECHNICAL FIELD

This patent document relates to systems, devices, and processes that use cloud computing technologies for building, updating, maintaining or monitoring enterprise computer systems.

### BACKGROUND

Cloud computing is an information technology that enables ubiquitous access to shared pools of configurable resources (such as computer networks, servers, storage, applications and services), which can be rapidly provisioned with minimal management effort, often over the Internet.

Cloud computing service providers often provide programmable infrastructures that can be automated using Infrastructure as Code (IaC) approach. As the name suggests, Infrastructure as Code is a way of managing the cloud environment in the same or similar way as managing application code. Rather than manually making configuration changes or using one-off scripts to make infrastructure adjustments, the IaC approach instead allows the cloud infrastructure to be managed using the same or similar rules that govern code development—source code needs to be stored in a version control system, to allow for code reviews, merging, and release management. Many of these practices require automated testing, the use of staging environments that mimic production environments, integration testing, and end-user testing to reduce the risk of failed deployments resulting in system outages.

### SUMMARY

Techniques, systems, and devices are disclosed for implementing a system that uses machine generated infrastructure code for software development and infrastructure operations, allowing automated deployment and maintenance of a complete set of infrastructure components.

In one exemplary aspect, a system for managing data center and cloud application infrastructure is disclosed. The system includes a user interface configured to allow a user to select a plurality of components from a pool of available components, each of the components providing one or more infrastructure capabilities for integration into a complete application infrastructure environment that includes at least network, data storage, and business logic capabilities; and a management platform in communication with the user interface, wherein the management platform is configured to (1) create a template based on the plurality of components. The template includes a set of files describing the plurality of components and corresponding integration parameters of the plurality of components for the complete web system, (2) generate a set of infrastructure code based on the template to allow automatic configuration of the plurality of components and integration of the plurality of components into the complete web system, wherein the user interface is further configured to allow the user to deploy the plurality of components for the complete web system using the set of infrastructure code such that the plurality of components is automatically configured and integrated to form the complete web system on one or more network targets.

In another exemplary aspect, a method for managing data center and cloud application infrastructure by a computer is disclosed. The method includes selecting a plurality of components from a pool of available components, wherein each of the components provides one or more infrastructure capabilities for integration into a complete application infrastructure environment that includes at least network, data storage, and business logic capabilities; operating a management platform to generate (1) a template based on the plurality of components, wherein the template includes a set of files describing the plurality of components and corresponding integration parameters of the plurality of components for the complete web system, and (2) a set of infrastructure code based on the template to allow automatic configuration of the plurality of components and integration of the plurality of components into the complete web system; selecting one or more network targets for hosting the complete web system; and deploying the plurality of components for the complete web system using the set of infrastructure code such that the plurality of components are automatically configured and integrated to form the complete web system on the one or more network targets.

In yet another exemplary aspect, a non-volatile, non-transitory computer readable medium having code stored thereon and when executed by a processor causing the processor to implement a method. The method comprises providing a user interface to allow a user to select a plurality of components from a pool of available components, each of the components providing one or more infrastructure capabilities for integration into a complete application infrastructure environment that includes at least network, data storage, and business logic capabilities; creating a template based on the plurality of components, wherein the template includes a set of files describing the plurality of components and corresponding integration parameters of the plurality of components for the complete web system; generating a set of infrastructure code based on the template to allow automatic configuration of the plurality of components and integration of the plurality of components into the complete web system. The user interface is configured to allow the user to deploy the plurality of components for the complete web system using the set of infrastructure code such that the plurality of components is automatically configured and integrated to form the complete web system on one or more network targets.

The details of one or more implementations of the above and other aspects are set forth in the accompanying drawings, the description and the claims.

### BRIEF DESCRIPTION OF THE DRAWINGS

FIG. 1 shows exemplary SuperStacks tailored to different architecture standards in accordance to one or more embodiments of the disclosed technology.

FIG. 2A shows an exemplary diagram of manual maintenance of different stacks.

FIG. 2B shows an exemplary diagram of using automatic scripting capability to centrally manage interdependencies and configuration among different stack components in accordance to one or more embodiments of the disclosed technology.

FIG. 3A shows an exemplary diagram of how software development and operations (DevOps) teams can use SuperHub Control Plane to generate SuperHub stack templates to allow easy management of deployment and development of the SuperStacks in accordance to one or more embodiments of the disclosed technology.

FIG. 3B shows an example of different environment configurations for development, testing, and production in accordance to one or more embodiments of the disclosed technology.

FIG. 3C shows an exemplary user interface demonstrating details of a SuperStack in accordance to one or more embodiments of the disclosed technology.

FIG. 3D shows an example of deploying an entire SuperStack by clicking on a single button in accordance to one or more embodiments of the disclosed technology.

FIG. 4 shows some exemplary pre-built SuperStacks in accordance to one or more embodiments of the disclosed technology.

FIG. 5 shows an exemplary user interface that allows technical teams to build customized SuperHub stack templates in accordance to one or more embodiments of the disclosed technology.

FIG. 6 is a flowchart representation of code generation performed by SuperHub for a SuperStack in accordance to one or more embodiments of the disclosed technology.

FIG. 7A shows an exemplary structure of a repository for a SuperStack in accordance to one or more embodiments of the disclosed technology.

FIG. 7B shows an exemplary template hub.yam1 manifest in accordance to one or more embodiments of the disclosed technology.

FIG. 7C shows an exemplary set of parameter settings for components in accordance to one or more embodiments of the disclosed technology.

FIG. 8 is a flowchart representation of an operation that allows SuperHub to automatically integrate all components with required parameters in accordance to one or more embodiments of the disclosed technology.

FIG. 9 is a flowchart representation of a component-level operation named “Elaborate” to allow SuperHub to deploy or undeploy operation in accordance to one or more embodiments of the disclosed technology.

FIG. 10 is a flowchart representation of stack-level operations of SuperHub.

FIG. 11 shows an exemplary user interface indicating teams and their respective permissions in accordance to one or more embodiments of the disclosed technology.

FIG. 12A shows an example of adding tags to deployment instances in SuperHub Control Plane in accordance to one or more embodiments of the disclosed technology.

FIG. 12B shows some exemplary plots of usage data by different SuperStacks, including memory usage, CPU usage, file system usage, and data file system usage in accordance to one or more embodiments of the disclosed technology.

FIG. 12C shows an exemplary diagram of compiled usage and cost data from various deployed stack instances in accordance to one or more embodiments of the disclosed technology.

FIG. 13 is a flowchart representation of how a user can create and deploy a SuperStack using the technology provided by Agile Stacks in accordance to one or more embodiments of the disclosed technology.

FIG. 14 is a flowchart representation of a method for managing data center and cloud application infrastructure by a computer in accordance to one or more embodiments of the disclosed technology.

FIG. 15 is a block diagram illustrating an example of the architecture for a computer system or other control device that can be utilized to implement various portions of the presently disclosed technology.

### DETAILED DESCRIPTION

The cloud is a term that refers to services offered on a computer network or interconnected computer networks (e.g., the public internet) that allow users or computing devices to allocate information technology (IT) resources for various needs. Customers of a cloud computing service may choose to use the cloud to offset or replace the need for on-premise hardware or software. A cloud infrastructure includes host machines that can be requested via an Application Programming Interface (API) or through a user interface to provide cloud services. Cloud services can also be provided on a customer's own hardware using a cloud platform.

A cloud computing service has quickly emerged as the primary platform for enterprises' digital businesses. The increasing pace of development in tools and cloud services resulted in growing complexity of programmable infrastructure. For example, Amazon Web Services (AWS) started with two services and grew to offer 300+ services. There are dozens of tools such as Terraform, Chef, Ansible, CloudFormation, etc. available on the cloud. Various software infrastructure tools, such as Docker, Kubernetes, Prometheus, Sysdig, Ceph, MySQL, PostgreSQL, Redis, etc., are used as platforms on which other software can be built.

Various traditional cloud computing approaches require system administrators to manually configure all components or a team of developers to manually create a set of custom automation scripts or programs to deploy all infrastructure components in an automated way. Such cloud computing approaches tend to be labor intensive and timing consuming and therefore usually require significant time for deploying certain updates or replacements in a customer's enterprise computing system on the cloud. For example, it is not uncommon for software development and operation (DevOps) engineers to spend several months of effort in writing a large number of lines of infrastructure code to deploy and manage cloud infrastructure and application stack components. Manual approaches also require ongoing effort to maintain automation scripts, test against security risks, and upgrade to new versions of components, thus adding additional cost and delays. For another example, software modules or components from different software developers or vendors that are used in an enterprise computing system on the cloud may be frequently upgraded and the newer versions with desired improved or enhanced functionalities may have compatibility issues with one or more software modules or tools in the enterprise computing system and such computability must be addressed individually in the manual approach. In light of the increasing complexity of enterprise computing systems on the cloud and the increasingly large number of different software modules and tools are deployed, manual management or manual custom automation with automated deployment are increasingly inadequate. For yet another example, manual management or manual custom automation with automated deployment can be prone errors due to the nature of the human operations and the labor-intensive and time-consuming process for upgrading and deployment must be repeated each time something needs to be changed in an enterprise computing system on the cloud.

Under such cloud computing approaches, organizations with their enterprise computing systems on the cloud may have to choose between a custom-built cloud that maximizes flexibility in using best-of-breed tools at a considerable cost in time and resources, or an all-in-one solution limited to a platform-as-a-service (PaaS) vendor's designated tools. In recognition of the technical challenges in the existing manual management or manual custom automation with automated deployment for maintaining or updating enterprise computing systems on the cloud, this patent document describes techniques and architectures, referred to as Agile Stacks, that allow centralized and automatic management of a complete set of integrated cloud computing components. The disclosed techniques and architectures allow complex cloud automation development and testing processes to be carried out quickly, reliably, without the limitations presented in PaaS tools or the onerous effort required in custom-built solutions and yet allowing for customization in cloud development and testing.

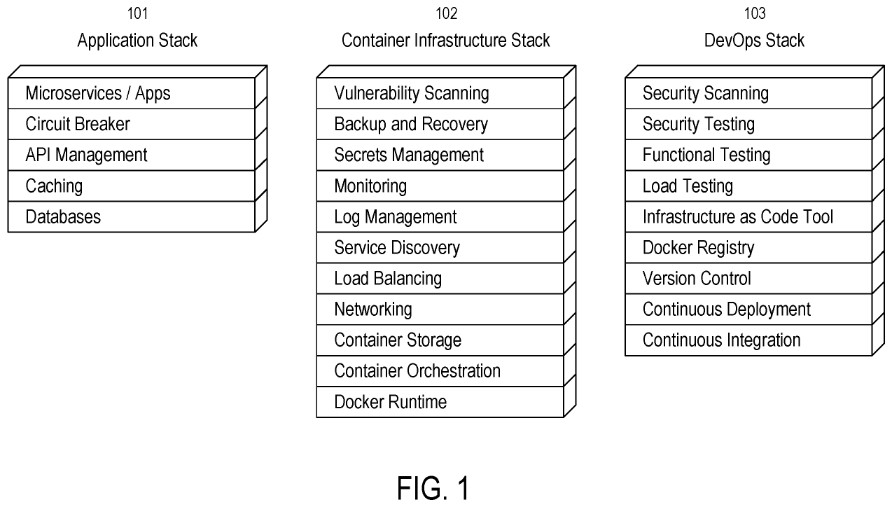

The term SuperStack can be viewed as a set of software components, modules, tools, services (e.g., Software-as-a-Service (SaaS) based software tools and/or cloud services) that are integrated to work together and can be maintained together over time. Each SuperStack can provide a platform on which other software components, modules, tools, or services can be built. FIG. 1 shows some exemplary SuperStacks tailored to different architecture standards in accordance to one or more embodiments of the disclosed technology. For example, databases, caching services, an application programming interface (API) management system, a circuit breaker system (i.e., a design pattern used in modern software development to detect failures and encapsulates the logic of preventing a failure from constantly recurring), and upper level micro-services and/or applications form an exemplary stack 101. In another example, services such as Docker runtime, container orchestration, container storage, networking, load balancing, service discovery, log management, runtime monitoring, secrets management, backup and recovery, and vulnerability scanning form another exemplary stack 102. In yet another example, continuous integration, continuous deployment, version control, Docker registry, Infrastructure as Code tool, load testing, functional testing, security testing, and security scanning form an exemplary stack 103.

These examples demonstrate that stacks are extremely flexible. In this patent document, the term “SuperStack”, also referred to as “stack” and used interchangeably, means a complete set of integrated components that enables all aspects of a cloud application—from network connection, security, monitoring, system logging, to high level business logic. A SuperStack is a collection of infrastructure services defined and changed as a unit. Stacks are typically managed by automation tools such as Hashicorp Terraform, AWS CloudFormation. Using Agile Stacks, DevOps automation scripts can be generated and stored as code in a source control repository, such as Git, to avoid the need to manually create Terraform and CloudFormation templates. A SuperStack can be pre-integrated and/or tested to work together to provide a complete solution. Each SuperStack may correspond to a different architectural area with an independent set of rules for integration. One or multiple SuperStack instances can be combined with another SuperStack instance to allow for layered deployments and to provide additional capabilities for a running stack instance. Each layer can be independently deployed, updated, or undeployed. The stacks are combined together by merging all components into a single running stack instance.

Currently, the market for cloud automation includes a combination of tool vendors who make various tools, and cloud providers that offer services to help customers automate their cloud deployments. The tools are often referred to as “orchestrators” and commonly come in two flavors. One flavor includes the use of procedural languages in which the steps to be executed are described in sequence to configure various components and request services, including deployment. The other flavor includes declarative descriptions of the desired end-state for the infrastructure. The tool then either knows how to achieve the end-state automatically, or the code included in the description enables the tool to execute steps to achieve the end-state.

The cloud computing services typically provide APIs to allow customers to allocate hosts (i.e., computers) and to define network settings. The normal procedure is to deploy one or more virtual machine (VM) images onto a host computer. These virtual machine images are composed by the customer to contain all the functionality of a service they want to deploy. In particular, a technique called “container” (also referred to as container image technology) packages all of the dependencies for an application into a single named asset to provide a way to deploy smaller pieces of software functionality in the cloud faster. In this patent document, the term “container” refers to any container format that packages dependencies of a software application.

Some vendors offer services such as Platform as a Service (PaaS) for deployment in the cloud. These services contain a number of functions that enable a customer to build software and deploy it into a cloud. Because a PaaS vendor has selected the components to perform the functions of a PaaS, the predefined set of tools included in the PaaS is often opinionated. Frequently, PaaS vendor promotes its own products to the predefined set of tools.

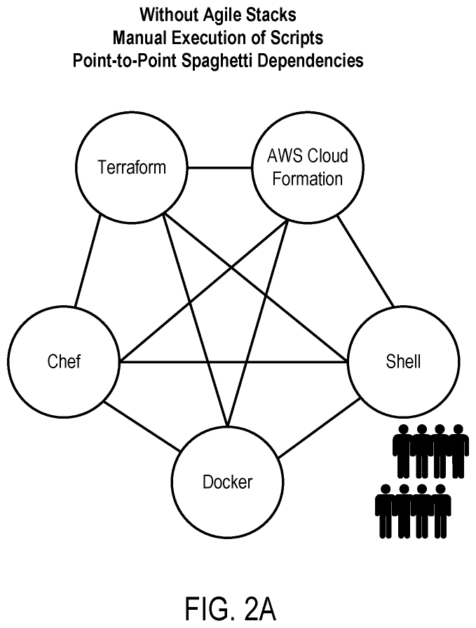

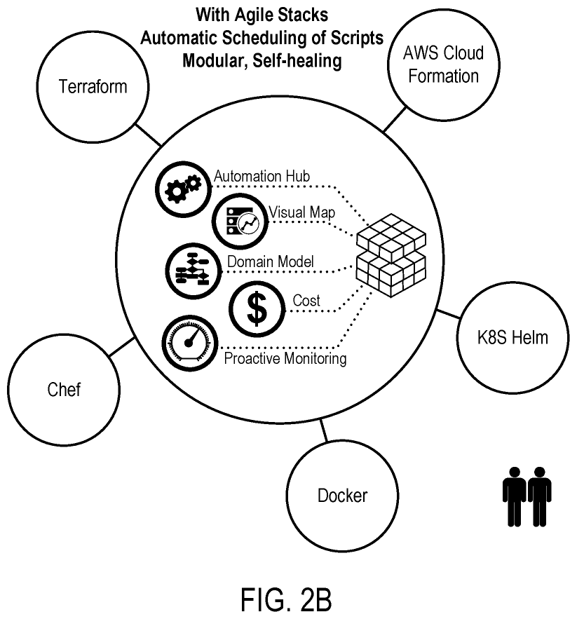

Because of the flexibility offered by custom built stacks, a common problem that many enterprises face is that there is an ocean of tools available testing, orchestration, and deployment of the components of the stack. In order to leverage different products that are pre-tested, integrated, and work together from the instant they are deployed, enterprises need to invest considerate amount of infrastructure and technical personnel to ensure that these products work together consistently and reliably. FIG. 2A shows an exemplary diagram of manual maintenance of different stacks and bespoke DevOps automation scripts. Often times, point-to-point dependencies among different components can lead to a tremendous amount of engineering time and effort. In particular, newer versions of a particular stack and/or component can introduce compatibility problems with other existing stacks and/components, leading to repetitive engineering maintenance and testing to ensure that the stack can operate correctly again.

Alternatively, enterprises may opt for a set of opinionated tools provided by a vendor so as to avoid the amount of infrastructure and technical expertise that they need to invest. For example, self-contained stacks such as Bitnami Stacks do not interfere with any software already installed on the existing systems. However, it is difficult to integrate self-contained stacks into a complete solution—the end user is expected to resolve major configuration and integration challenges in order to achieve so.

FIG. 2B shows an exemplary diagram of using Hub based automatic scripting capability to manage interdependencies among different stacks in accordance to one or more embodiments of the disclosed technology. Agile Stacks offers a infrastructure as code based architecture that provides enterprises the automation to deploy their selections of SuperStack from multiple cloud and DevOps components quickly and reliably. Agile Stacks provides a large set of pre-configured and pre-tested SuperStack configurations to allow enterprises to deploy their selections automatically within minutes. Agile Stacks also provides organizations the flexibility to choose among popular, best-of-breed products and ensures that the selected components can be integrated successfully and can work together from the instant they are deployed. Technology teams, therefore, can confidently use the tools that best fit their needs. No longer do application development and DevOps teams need to struggle with consistency and stability across development, test, and production because Agile Stacks provides reliable and repeatable deployment of technology in many different environments.

Modern DevOps is based on at least three important aspects: infrastructure as code (IaC), continuous integration and continuous delivery (CI/CD), and automated operations. For example, IaC is the process of managing and provisioning computer data centers through machine-readable definition files, rather than physical hardware configuration or interactive configuration tools. IaC provides benefits for software development, including operability and security, event-based automatic execution of scripts, continuous monitoring, rolling upgrades, and easy rollbacks. Continuous integration and continuous delivery (CI/CD), on the other hand, is the practice of using automation to merge changes often and produce releasable software in short iterations, allowing teams to ship working software more frequently.

Agile Stacks is designed to be consistent with the important aspects of modern DevOps practices. Agile Stacks provides a SuperHub as a service that generates SuperHub stack templates for cloud environments, with built-in compliance, security, and best practices. For example, Agile Stacks can be built to support DevOps in the cloud, providing continuous integration/continuous development (CI/CD) while implementing a flexible toolchain that standardizes DevOps processes and tools. SuperHub performs as integration hub that connects all tools in the DevOps toolchain. Agile Stacks applies best practices for security, automation, and management to enable organizations to have a DevOps-first architecture that is ready for teams to build or copy a service into immediately across consistent development, test, and production stacks. This enables users to focus on implementing the business logic and their solutions while reducing their need for DevOps resources to support the infrastructure and DevOps cloud stacks.

The Agile Stacks system includes the following main components:
SuperHub Control Plane. The SuperHub Control Plane is a hybrid cloud managements tool that provides web interface designed to simplify stack configuration, thereby allowing technical teams to create a standardized set of cloud-based environments. Control Plane enables self-service environment provisioning, deployment of all tools in DevOps toolchain such as Jenkins, Git, Kubernetes, pre-configured with SSO and RBAC across all tools. The SuperHub Control Plane also provides reports based on tags and relevant information the system collects from stack deployments to improve visibility of cloud costs to the DevOps teams.
Prebuilt SuperStacks. The prebuilt SuperStacks include a set of SuperStack configurations that include best-of-breed software components. Agile Stacks pre-integrates and pre-tests the set of configurations to ensure that the components can be deployed and can work together seamlessly. Agile Stacks Kubernetes Stack provides turnkey solution to deploy Kubernetes on the AWS public cloud and on-prem bare metal, with regular patches and updates.
Orchestration and SuperStack Lifecycle Management (also referred to as SuperHub). Agile Stacks SuperHub provides auto-generated infrastructure code for stack lifecycle management including operations such as to change stacks configurations add, move, or replace components, deploy, backup, restore, rollback, clone. The SuperHub also provides command line utility and API to deploy the software components automatically onto platforms such as the Amazon AWS cloud account or other private cloud. The SuberHub further provides Docker toolbox to simplify and standardize the deployment of infrastructure as code automation tools on developer workstations and on management hosts. In some implementations, SuperHub allows technical teams to create automation tasks such as deployment, rollback, and cloning.

In some embodiments, Agile Stacks also includes components to support container-based micro-services framework and CI/CD pipeline, container-based machine learning pipeline, hybrid data center capability, and NIST-800 and/or HIPAA security practices.

SuperHub Control Plane

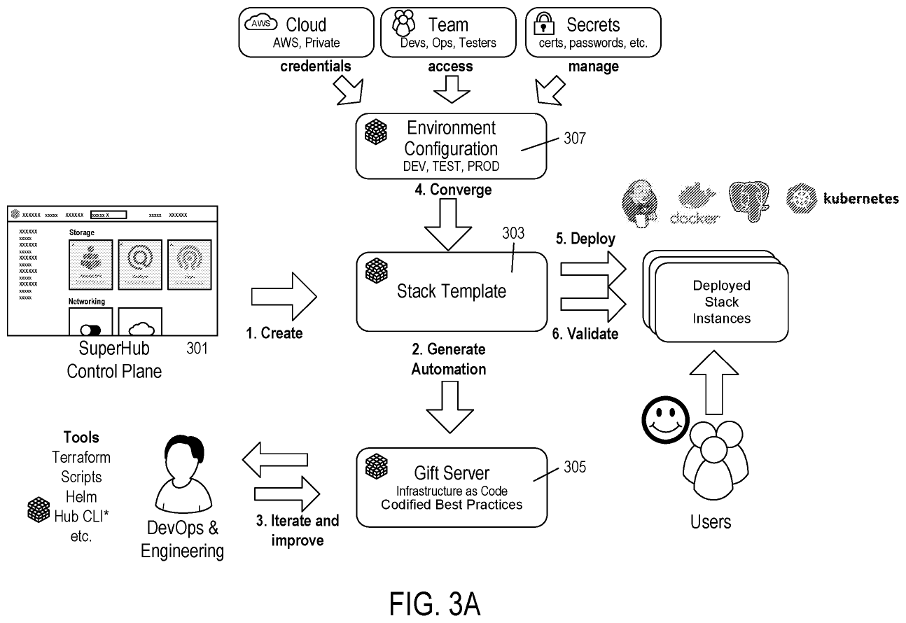

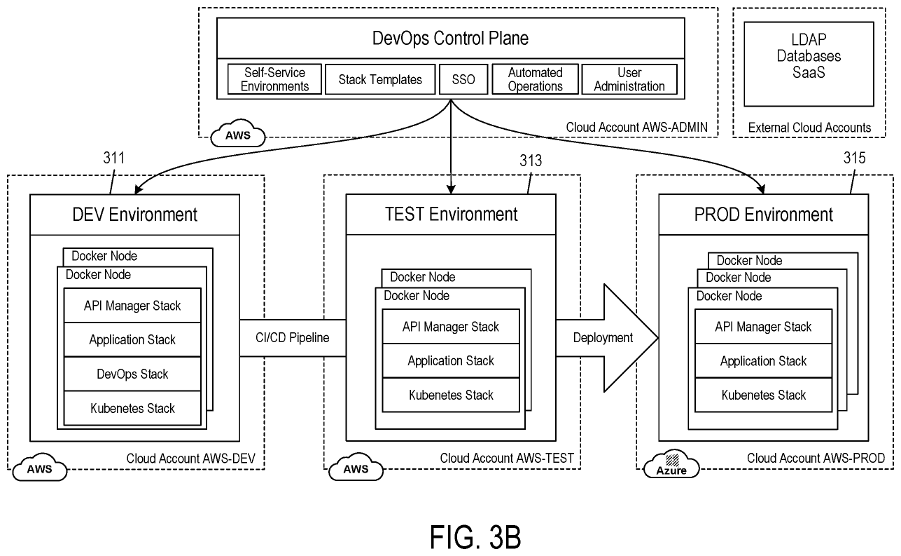

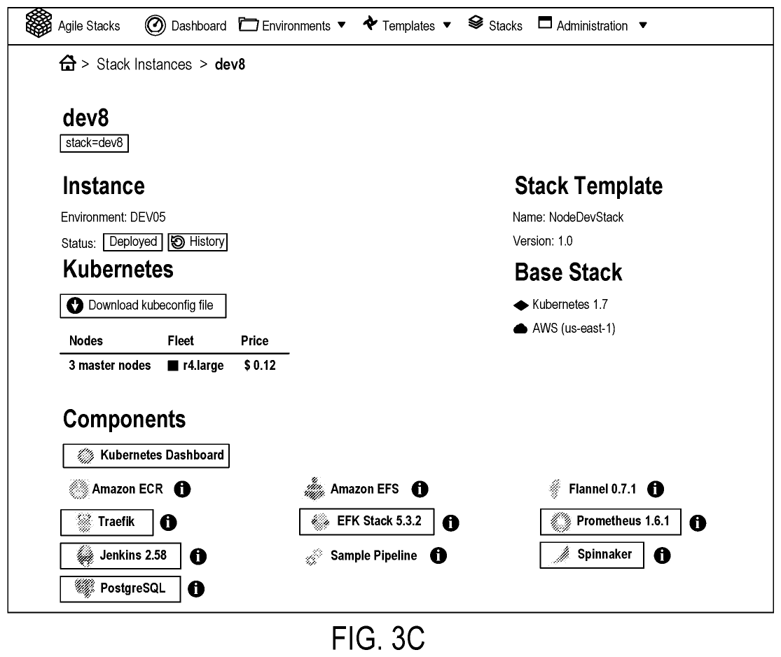

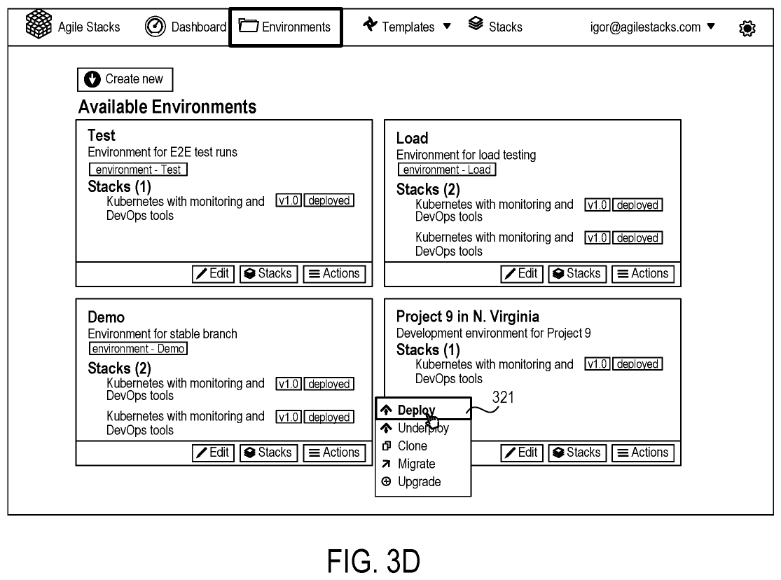

The SuperHub Control Plane is one of the key components of Agile Stacks. The SuperHub Control Plane simplifies stack configuration and allows technical teams to create a standardized set of cloud-based environments. FIG. 3A shows an exemplary diagram of how DevOps teams can use Agile Stacks SuperHub Control Plane 301 to generate SuperHub stack templates (e.g., a set of files describing the components used in the SuperStack and corresponding integration choices) to allow easy management of deployment and development of the SuperStacks in accordance to one or more embodiments of the disclosed technology. Using the SuperHub Control Plane 301, developers can select certain components so SuperHub stack templates 303 can be created. The SuperHub stack templates 303 are then used to generate human-readable infrastructure code automatically. The generated infrastructure code can be maintained and tracked using version control systems 305 such as Git servers. The generated infrastructure code can also be modified based on desired environment configurations 307 (e.g., development environment, testing environment, and production environment). For example, FIG. 3B shows an example of different environment configurations for development 311, testing 313, and production 315 in accordance to one or more embodiments of the disclosed technology. FIG. 3C shows an exemplary user interface demonstrating details of a SuperStack, including SuperHub stack template and components that the template includes, in accordance to one or more embodiments of the disclosed technology.

Deployment of the SuperStack is simple—Agile Stacks allows a single-operation deployment of the entire SuperStack. FIG. 3D shows an example of deploying an entire SuperStack by clicking on a single button in accordance to one or more embodiments of the disclosed technology. As shown in FIG. 3D, the entire Demo SuperStack can be deployed by clicking on a single button “Deploy” (321). This greatly simplified deployment process enables continuous deployment of the SuperStacks, providing continuous integration/continuous development (CI/CD) while implementing a flexible toolchain that standardizes DevOps processes and tools.

Updates to the running SuperStacks can be performed via an “Upgrade” operation. Parts of the stack automation that are changed by the end users or by AgileStacks can be applied to the running infrastructure. Provided that everything (infrastructure configuration, environment configuration, deployment pipeline) is made declaratively in stack definitions, Git (or similar) source control system can be the only tool needed by developers to perform their DevOps tasks. SuperStack definitions that are not explicitly managed by the user can be changed by AgileStacks platform, enabling the desired state to be cooperatively determined by both users and regular updates provided by Agile Stacks. Git version control capability to perform code merge operation allows the ability to implement regular and automated updates without custom migration operations, manual updates, and/or configuration customization, such as for overriding environment specific properties. In addition to the code merge capability, the Git version control is capable to track the history of changes and even revert a change from history if request by end user.

Pre-Built SuperStacks

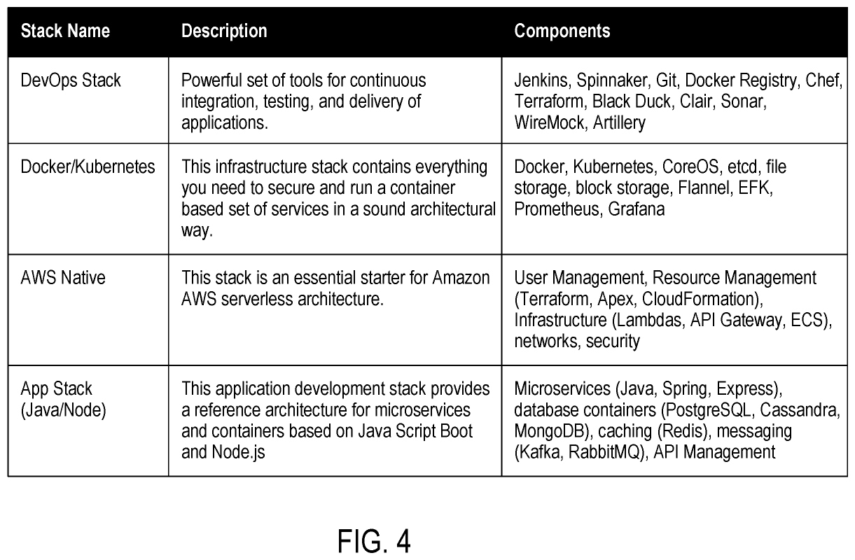

As discussed above, Agile Stacks provides a set of pre-built SuperStacks that are pre-integrated and pre-tested. FIG. 4 shows some exemplary pre-built SuperStacks in accordance to one or more embodiments of the disclosed technology. As shown in FIG. 4, a pre-built SuperStack may include a DevOps stack, a Docker/Kubernetes stack, a AWS native stacks, an application (App) stack, or other types of stacks such as a Machine Learning stack. The DevOps stack provides a powerful set of tools for continuous integration, testing, and delivery of application, and may include components such as Jenkins, Spinnaker, Git, Docker Registry, Chef, etc. The Docker/Kubernetes stack contains components to secure and run a container-based set of services, and may include components such as Docker, Kubernetes, CoreOS, etc. In some embodiments, a Machine Learning Stack enables teams to automate the entire data science workflow, from data ingestion and preparation to inference, deployment and ongoing operations. The AWS Native stack is an essential starter for the AWS serverless architecture and may include user management, resource management (such as Terraform, Apex), infrastructure (Lambdas, API Gateway), networks, and security. The App stack provides a reference architecture for micro-services and containers, and may include micro-services (such as Java, Spring, Express), database containers, caching, messaging, and API Management.

The set of pre-built SuperStacks is selected by Agile Stacks by testing all combinations of available components (including different versions of components) to determine if those components can function together. The Agile Stacks system may include a test engine that performs functional, security, and scalability tests to determine which combinations meet a set of pre-defined criteria. In some embodiments, the system may record the testing results (including failures and successes) in a compatibility matrix. It then can make upgrades to the existing SuperSuperHub stack templates based on the testing results—users no longer need to perform testing for individual components as a part of the upgrade. The compatibility matrix also allows Agile Stacks to disable certain combinations.

In some embodiments, the set of pre-configured SuperStacks are provided in the form of SuperHub stack templates. Using the SuperHub Control Plane, developers can simply select one of the pre-configured templates that incorporates their preferred tools. The stack automation platform, SuperHub, then starts automatic execution of the infrastructure code generated based on the template to run the stacks, eliminating the complexity and vulnerabilities associated with manual execution.

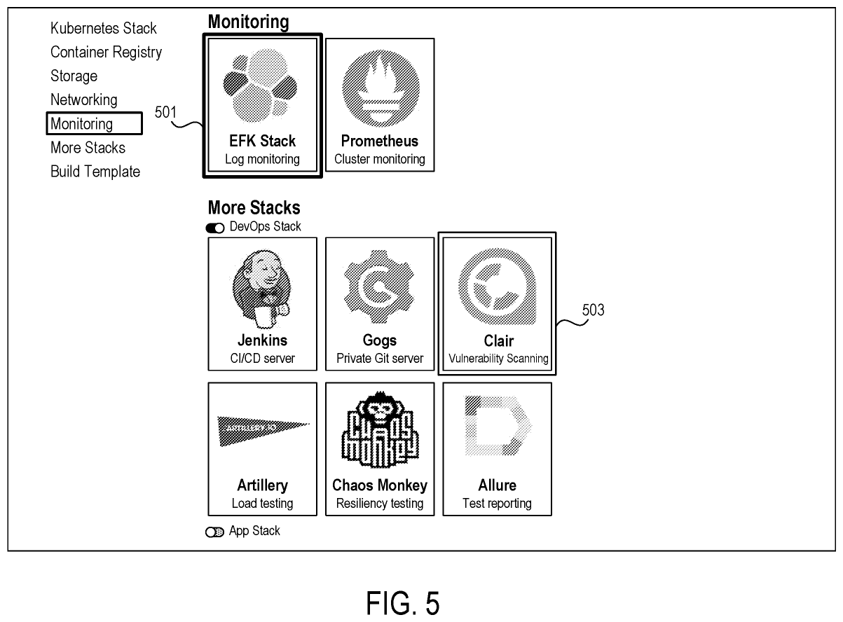

Agile Stacks also provides the flexibility for the developers to select individual stacks/components that are suitable for their business needs. This allows an easier transition from existing ad-hoc management of stacks to the use of Agile Stacks: technical teams can simply refactor existing framework and tell Agile Stacks about the components that are currently in use. FIG. 5 shows an exemplary user interface that allows technical teams to build customized SuperHub stack templates in accordance to one or more embodiments of the disclosed technology. Stack components can be organized into categories such as storage, networking, monitoring, or security. For example, in FIG. 5, Elasticsearch, Fluentd, and Kibana (EFK stack) is selected as the stack to be used for system monitoring within the SuperStack configuration. ElasticSearch is a schema-less database that has powerful search capabilities and is easy to scale horizontally. Fluentd is a cross-platform data collector for unified logging layer. Kibana is a web-based data analysis and dashboard tool for ElasticSearch that leverages ElasticSearch's search capabilities to visualize big data in seconds.

Once the EFK stack (501) is selected, only the stacks that have been pre-tested to work with EFK remain active in the SuperHub Control Plane to ensure that the custom selected components/stacks can work together. The stacks that have been determined to be incompatible with EFK stack (e.g., Clair 503), based on the compatibility matrix generated during the testing stage, are marked as unavailable by Agile Stacks. Developers can proceed to select all relevant components to be used in the SuperStack and let the system create a corresponding SuperHub stack template.

SuperHub

SuperHub (also referred to as Automation Hub) provides cloud-based software for cloud management, cloud automation, cloud control and management of software by machine generated infrastructure code based on the generated SuperHub stack templates. It also provides automation for deploying cloud infrastructure in managed ways to insure and monitor compliance across an organization.

Once the stacks/components are selected in the SuperHub Control Plane, the system generates a corresponding SuperHub stack template and saves it to a version control system. It is noted that source code management and versioning tools, such as Git or Subversion, have been used successfully by software development teams to manage application source code. The use of version control system allows developers to choose a specific SuperHub stack template (e.g., a particular version for a particular architecture) to perform an operation on demand.

A key feature of SuperHub is its ability to generate the latest and best automation for a specific SuperSuperHub stack template for an on-demand operation. This automation is provided in the form of machine generated infrastructure code (also referred as DevOps Automation Code). It is noted that infrastructure code is the type of code that is used in the practice of Infrastructure as code (IaC), which is the process of managing and provisioning computer data centers through machine-readable definition files, rather than physical hardware configuration or interactive configuration tools. The automation can use either scripts or declarative definitions, rather than manual configuration processes, and the infrastructure comprises both physical equipment such as bare-metal servers as well as virtual machines and associated configuration resources.

The automatically generated infrastructure code can be executed by SuperHub to perform operations immediately, or at a later scheduled time when desired. The code generation of SuperHub takes into account the cloud provider(s) that the SuperStack will run on, the combination of components and resources required, the use cases and configuration items, and priorities of optimization. The same stack template can often be deployed on multiple cloud providers, helping users to define and manage large scale multi-cloud infrastructure. The code generation also takes into account the user's usage data collected through automated data collection across all customers. Based on this usage data, the SuperStack can be deployed and optimized to run in the most economical and most secure manner.

In some embodiments, SuperHub generates a YAML Markup Language (YAML) like language that describes not only the components but details about the configurations for the deployment. For example, after a customized template is created via SuperHub Control Plane 301, a version control repository 305 (e.g., a Git repository) is created by SuperHub with following content:

1. Makefile with targets: deploy, undeploys.

2. hub.yam1 with from Stack: k8s-aws:1 and selected components.

3. params.yam1 settings for k8s-aws and included components.

4. Source code of the included components as sub-trees and/or sub-modules of Agile Stacks components.

5. Source code of automation scripts created in Shell, Terraform, Chef, and other infrastructure configuration languages, as well as references to external files containing automation scripts. Based on the template, the system knows which automation files to execute and in what order.

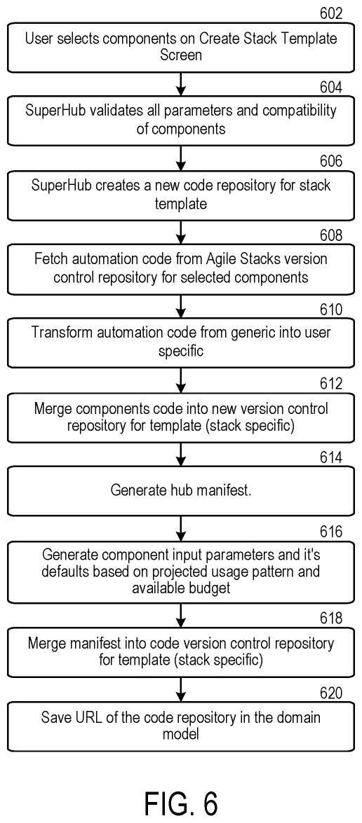

FIG. 6 is a flowchart representation of code generation performed by SuperHub for a SuperStack in accordance to one or more embodiments of the disclosed technology. In step 602, a user selects components using the SuperHub Control Plane (e.g., on “Create SuperHub stack template” screen). In step 604, SuperHub validates all parameters provided by the user and check compatibility of the components. In some embodiments, SuperHub checks compatibility on the fly while the user selects components via the SuperHub Control Plane. In step 606, SuperHub creates a new code repository for this particular SuperHub stack template. In step 608, SuperHub fetches automation code from a central version control repository for the selected components. In step 610, SuperHub transforms the generic automation code that it fetches from the central repository into user-specific code. In step 612, SuperHub merges component code into the new repository for this particular SuperHub stack template. In step 614, SuperHub generates a hub manifest file. In step 616, SuperHub also generates component input parameters. In some embodiments, based on its knowledge of the user (e.g., usage pattern and budget), SuperHub further modifies the parameters to adapt to the user's needs. In step 618, SuperHub merges manifest into the version control repository to generate a stack-specific template. Then, in step 620, SuperHub saves a uniform resource locator (URL) of the repository in its domain model.

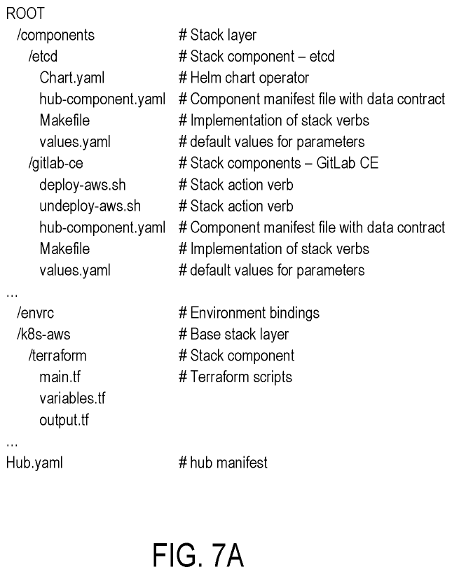

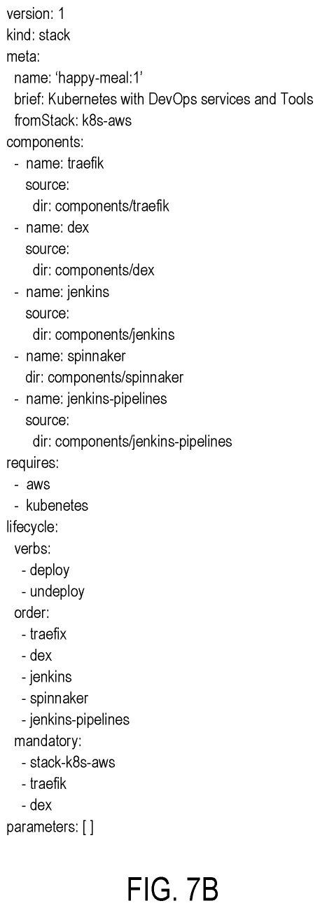

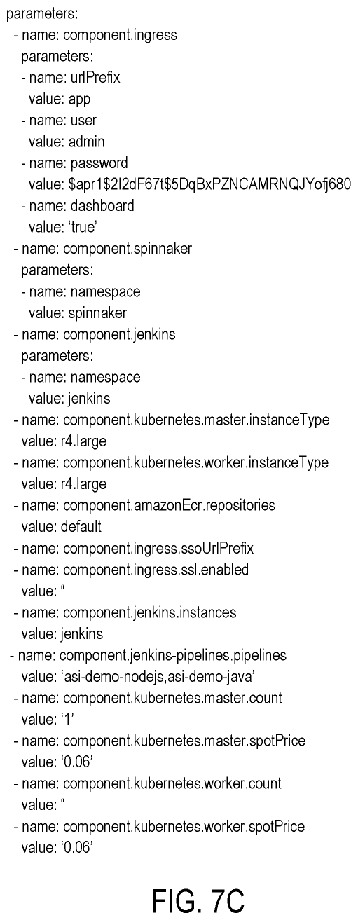

FIG. 7A shows an exemplary structure of a repository for a SuperStack in accordance to one or more embodiments of the disclosed technology. Components in the repository can be organized in a chain in which each component can have corresponding input and output parameters. A SuperStack is complete when all parameters can be provided by the user, or by components, or computed by the operation. FIG. 7B shows an exemplary template hub.yam1 manifest in accordance to one or more embodiments of the disclosed technology. FIG. 7C shows a corresponding exemplary set of parameter settings for the components in accordance to one or more embodiments of the disclosed technology.

Besides the manifest and parameter settings, SuperHub also generates a stack description that includes all the code for each of the supported operations on the entire stack. Some of the exemplary operations include:

Deploy: deploy a new component or a SuperStack.

Undeploy: undeploy the component or the SuperStack.

Clone: create a copy of a full-stack instance. In some embodiments, cloning can be done with slightly different attributes (e.g., in a different region or with different virtual machine sizes).

Status: return currently known status of the SuperStack.

Check and Repair: perform checks to diagnose problems of the SuperStack, and optionally repair it (e.g., by triggering component replacement).

Upgrade: update the SuperHub stack template version of to the latest release from Git version control repository.

Rollback: reverse update operation back to the previous version of SuperHub stack template.

Backup: backup stack data, so that a new instance could be provisioned from the saved state.

Restore: restore the stack by deploying from a data snapshot.

Agile Stacks also allows technical teams to customize stack configurations via scripting. In some embodiments, SuperHub provides a set of application programming interfaces (APIs) so that developers can modify the generated infrastructure code to add, move, catalog, tag, and/or replace components.

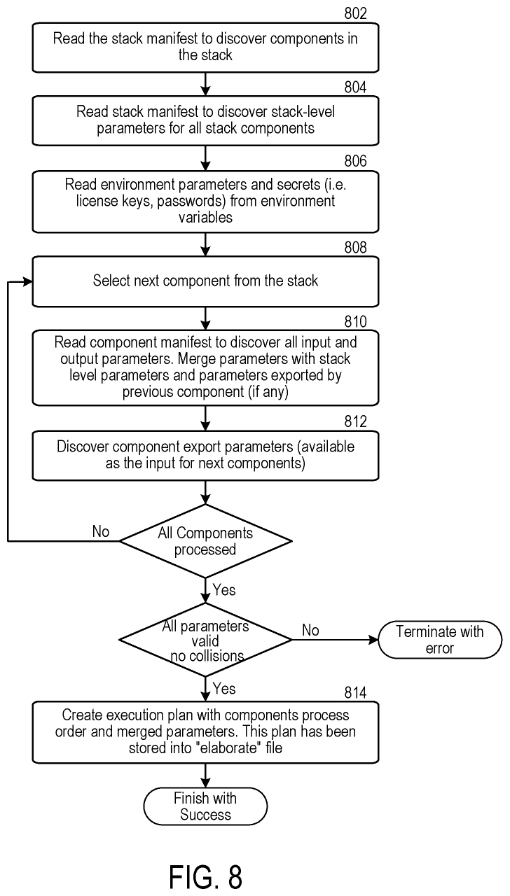

FIG. 8 is a flowchart representation of an operation that allows SuperHub to automatically integrate all components with required parameters in accordance to one or more embodiments of the disclosed technology. In step 802, SuperHub reads the stack manifest previously generated to discover components in the stack. In step 804, SuperHub reads the stack-level parameters for all stack components. In step 806, SuperHub reads environment parameters and other security-related parameters such as license keys or password. In step 808, SuperHub then selects the next component to process from the stack. In step 810, SuperHub reads the relevant input and output parameters, and merges them with stack-level parameters along with parameters exported by the previous component (if there is any). In step 812, SuperHub determines export parameters for the next component. SuperHub repeats steps 808-812 until all components are processed and validates, in step 814, that all parameters of the components have no collisions.

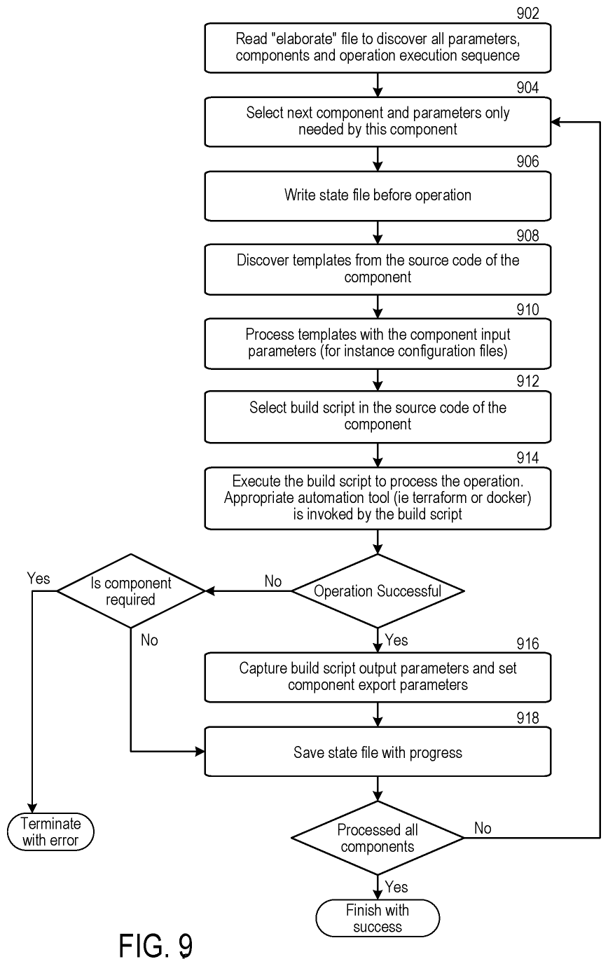

FIG. 9 is a flowchart representation of a component-level operation named “Elaborate” to demonstrate how SuperHub handles deployment or undeployment in accordance to one or more embodiments of the disclosed technology. In step 902, SuperHub reads a file for the “Elaborate” operation to discover all parameters, components, and the execution sequence. In step 904, SuperHub selects the next component and the parameters required by this particular component. In step 906, SuperHub writes to a state file before the start of the operation. In step 908, SuperHub determines component-level templates from the source code of the component. In step 910, SuperHub processes the component-level templates with the component input parameters (e.g., parameters from configuration files). In step 912, SuperHub selects a build script from the source code of the component. In step 914, SuperHub executes the build script to perform the operation. Various automation tools, such as Terraform or Docker, can be invoked by the build script. If the operation is performed successfully, SuperHub captures, in step 916, the output parameters from the build script and sets corresponding export parameters. Then in step 918, SuperHub saves the state file with the current progress. SuperHub repeats steps 904-918 until all components are processed for the operation.

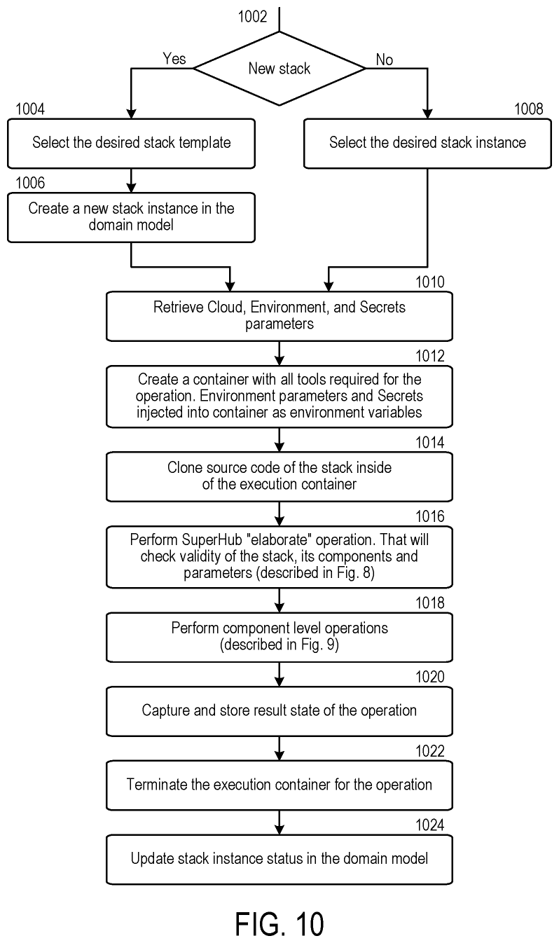

FIG. 10 is a flowchart representation of stack-level operations of SuperHub in accordance to one or more embodiments of the disclosed technology. In step 1002, SuperHub first determines if the stack is a new stack. If the SuperStack is new, SuperHub selects, in step 1004, a desired SuperHub stack template and create, in step 1006, a new SuperStack instance in the domain model. A SuperStack instance is a running version of a SuperSuperHub stack template that contains all the components and integration details as specified in the template. If the SuperStack is an existing one, SuperHub simply selects, in step 1008, a desired SuperStack instance. After obtaining the SuperStack instance, in step 1010, SuperHub retrieves parameters such as cloud, environment, and security-relate parameters. In step 1012, SuperHub creates a container with all the tools requires for the operation. The retrieved parameters are now injected into the container. In step 1014, SuperHub clones the source code inside of the exaction container of the SuperStack. In step 1016, SuperHub performs “Elaborate” operation as depicted in FIG. 8. In step 1018, SuperHub performs component-level operations as depicted in FIG. 9. SuperHub then captures and stores, in step 1020, the result state of the operation. After terminating the execution container in step 1022, SuperHub updates the status of the SuperStack instance in the domain model in step 1024.

With stack-level operations as shown in FIG. 10, SuperHub is capable of upgrading/modifying the entire SuperStack or groups of SuperStacks in different environments with pre-integrated and tested stack releases. This allows a significant reduction of integration problems because various combinations of stacks in the SuperStacks have been tested against the changes in advance.

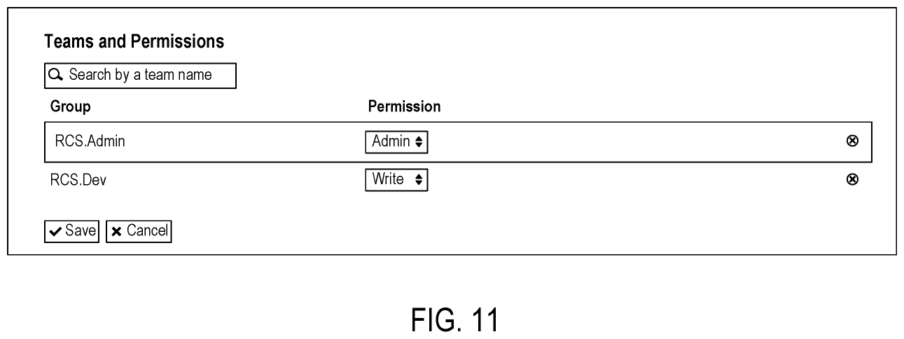

Additionally, using the SuperHub Control Plane, developers and administrators can properly secure all configuration management environments and continuous delivery pipelines. To ensure security of DevOps pipeline, in some embodiments, single sign-on (SSO), role-based access control, and secret management are enabled for all tools in the DevOps toolchain. FIG. 11 shows an exemplary user interface indicating teams and their respective permissions in accordance to one or more embodiments of the disclosed technology.

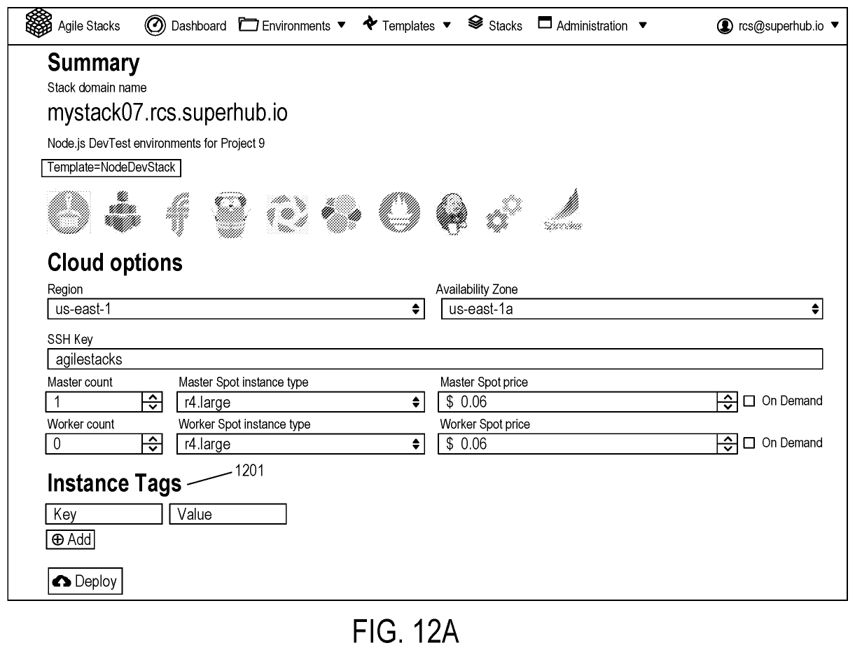

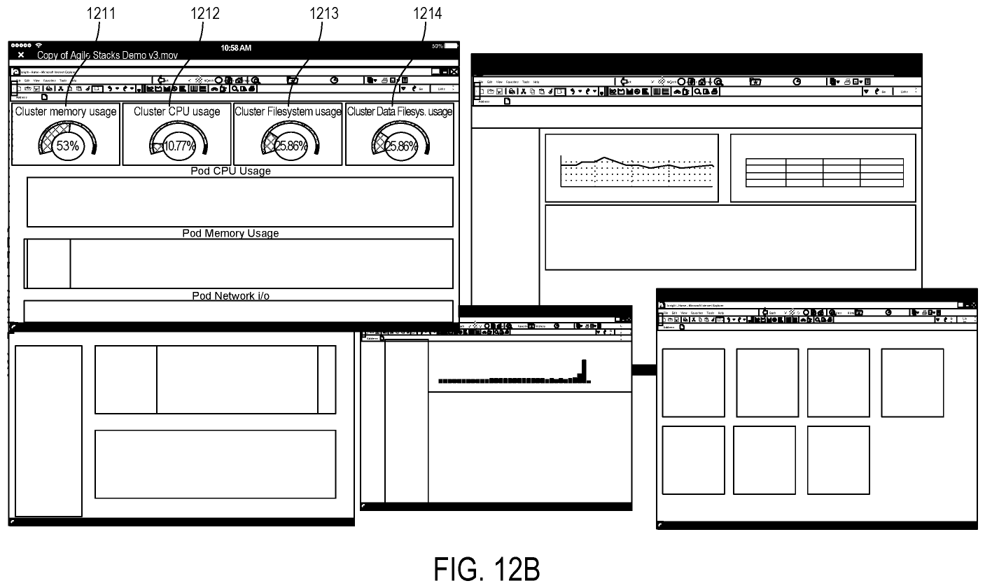

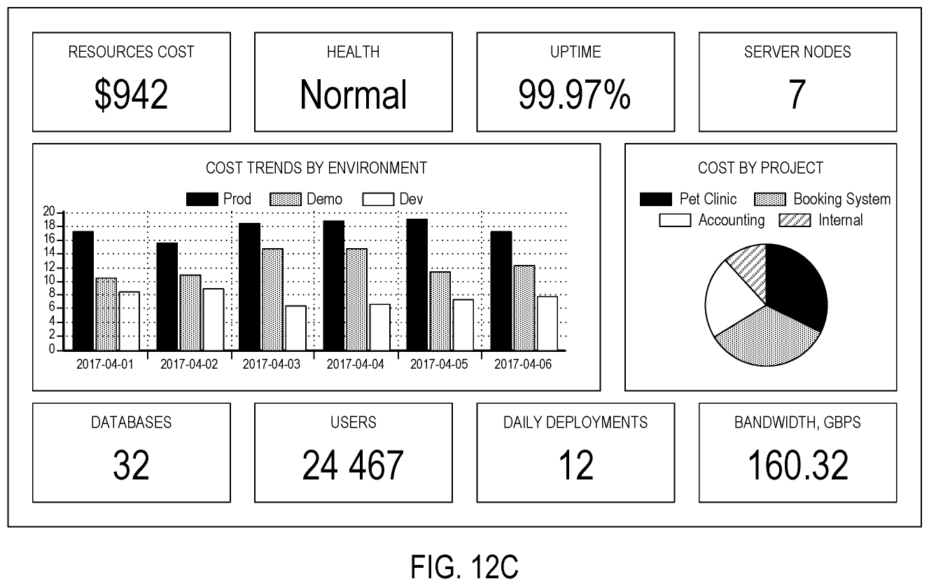

In addition, because all the infrastructure code is automatically generated based on SuperHub stack templates, Agile Stacks can automatically insert proper tags in the infrastructure code to collect usage information from the stacks. Developers also have the options to include particular tags, via SuperHub, to target particular usage areas. FIG. 12A shows an example of adding tags 1201 to deployment instances in SuperHub Control Plane 301 in accordance to one or more embodiments of the disclosed technology. Each tag can have a form of a key-value pair. Based on the tags, Agile Stacks collects useful information regarding resource usages on the cloud. The information can be saved into the central repository from all users. This information may be anonymized so that customer name, personal information, or transaction details are excluded.

Usage data may include at least one of the following: the number of hosts, processor type, memory usage, central processing unit (CPU) usage, cost, applications, containers, and application performance metrics. FIG. 12B shows some exemplary plots of usage data by different SuperStacks, including memory usage 1211, CPU usage 1212, file system usage 1213, and data file system usage 1214, in accordance to one or more embodiments of the disclosed technology. FIG. 12C shows an exemplary report on SuperHub Control Plane demonstrating compiled usage and cost data from various deployed stack instances in accordance to one or more embodiments of the disclosed technology. Relevant pricing information, such as cost trends by environment and/or cost by project, can extracted based on the collected information. Using such information, the user can determine the appropriate pricing strategy for each of the stack instances. The user may also adjust the stack templates based on the pricing information to minimize cost and increase system stability.

The usage data is tagged so that it is possible to correlate usage and reliability under certain loads on different environments (clouds or hardware choices) that can be used to make decisions about reducing costs or projected costs. For example, SuperHub may run machine learning and numerical analysis to discover how much resources the components use. Such analysis can also be performed to determine component reliability under different loads. Based on the analysis, SuperHub is able to suggest what machines/targets should be used with what resources in combination with other components to produce the required performance, scale, security, and cost of the customer.

Agile Stacks may provide several optimization suggestions to its users. The first cost optimization technique is based on auto-scaling. In case of container based stacks, all servers are placed in auto-scaling groups. The number of servers is automatically increased or decreased based on the user defined scaling parameters such as CPU usage, memory usage, or average response time. The second technique is to leverage spot instances, which is unused cloud capacity available on-demand at a significant cost discount. While spot instances offer discounts of 70-90% from standard price, they require advanced automation to recover in case when a server needs to be interrupted. The third cost optimization technique is based on metric-driven cost optimization. Metric-driven cost optimization is based on cost and usage data automatically collected from all running stack instances. Usage data is collected from all components and matched with usage metrics such as number of container instances, number of requests per second, number of users, response time, number of failed responses, etc.

Certain parameters such as the type of servers, type of processors, amount of memory per user are critical deployment decisions that need to be guided based on application usage patterns and projected system load. The disclosed technology provides deployment parameter recommendations based on the projected usage patterns, desired level of reliability, and available budget. The technology can therefore recommend the right size of allocated computing resources based on the projected usage estimates, with constant optimization based on shifting usage patterns.

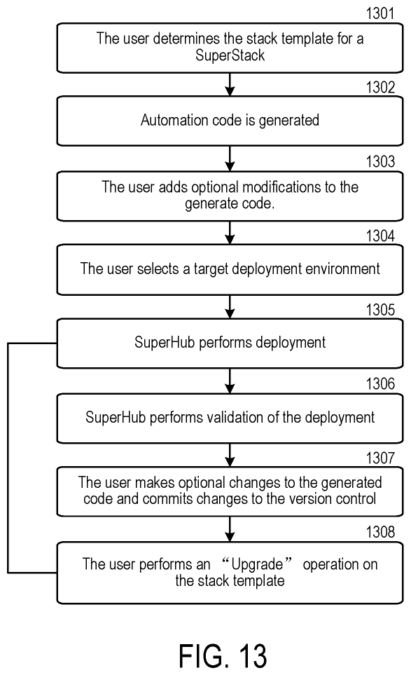

FIG. 13 is a flowchart representation of how a user can create and deploy a SuperStack using the technology provided by Agile Stacks in accordance to one or more embodiments of the disclosed technology.

Step 1301: the user determines the SuperHub stack template for a SuperStack. In particular, SuperHub Control Plane user interface offers a catalog of open source tools, commercial products, and SaaS cloud services that allows the user to define the SuperHub stack template. Configuration parameters to customize component deployment can be entered by the end user at this stage.

Step 1302: automation code is generated. The SuperHub stack template is automatically generated using Infrastructure as Code approach, and saved in a version control system. Stack components are code modules that are generated by SuperHub Control Plane based on user selection. Each component is a directory that contains: provisioning specification, code artifacts that contain actual infrastructure code to provision the stack component, stack state (e.g., expressed as a JSON file), and supported operations (e.g., stack component defines what needs to be done for a given operation). Besides deploy and undeploy capabilities, stack components might have implementation specifics for other operations like backup, rollback etc.

Step 1303: the user adds optional modifications to the generated code. Before deployment, DevOps and Engineering team members can retrieve the SuperHub stack template from the version control repository to review and improve automatically generated code. SuperHub stack templates can also be extended by adding custom components defined using any of the supported automation tools such as Terraform, Helm, etc. In some embodiments, SuperHub command line interface (CLI) can be used to create stack instances and test it. Once tested a SuperHub stack template is saved in versioned source control repository for future deployment.

Step 1304: the user selects a target deployment environment. In order to deploy a stack instance, the end user needs to select a target deployment environment. The environment will provide: a) cloud account security credentials; b) access details such as a list of teams authorized to access the stack instance, and c) environment specific secrets such as key pairs, user names/passwords, and license keys required by commercial components.

Step 1305: SuperHub performs deployment. Environment-specific automation scripts are executed by the automation hub to deploy all stack components automatically in the selected cloud environment. The system knows which external files to use with what tools and when to do them to complete a particular operation. If there are any problems with deploying the stack components, the hub will retry failed operations, ignore them while providing warnings to the end user, or abort deployment of the stack in case automation scripts fail to specify acceptable self-healing recovery actions.

Step 1306: SuperHub performs validation of the deployment. Deployed SuperStack instance is validated using a set of automated tests to determine if the new instance is deployed successfully. If automated testing steps complete successfully, then the stack instance state is changed to “Deployed” and end users are able to utilize the stack. In cased if critical tests fail, then the stack instance state is changed to “Failed” and end users are not allowed to use the stack. In case of successful validation, end users are able to immediately start using all deployed stack components, such as shown in FIG. 3C.

Step 1307: The user adds makes optional changes to the generated code. DevOps and Engineering team members can retrieve the SuperHub stack template from the version control repository to make changes to the automatically generated code. SuperHub stack templates can also be extended by adding custom components defined using any of the supported automation tools such as Terraform, Helm, etc. Modified stack template is saved in the versioned source control repository for future deployment.

Step 1308: The user performs an “Upgrade” operation on the stack template. The upgrade operation is available via Control Plane interface for any stack instances. Updates can be made by users or via monthly updates by Agile Stacks. In some embodiments, SuperHub CLI can be used to update stack instances and test it. SuperHub can apply all changes to the running instance, and redeploying or upgrading individual components as needed. SuperHub performs deployment of upgrades as in step 1305, allowing for continuous edits of stack templates and applying changes to the running stack instance.

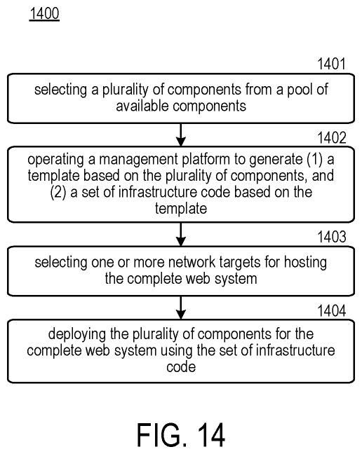

FIG. 14 is a flowchart representation of a method 1400 for managing data center and cloud application infrastructure by a computer in accordance to one or more embodiments of the disclosed technology. The method 1400 includes, at step 1401, selecting a plurality of components from a pool of available components. Each of the components provides one or more infrastructure capabilities for integration into a complete application infrastructure environment that includes at least network, data storage, and business logic capabilities. The method 1400 includes, at step 1402, operating a management platform to generate (1) a template based on the plurality of components, and (2) a set of infrastructure code based on the template to allow automatic configuration of the plurality of components and integration of the plurality of components into the complete web system. The template includes a set of files describing the plurality of components and corresponding integration parameters of the plurality of components for the complete web system. The method 1400 includes, at step 1403, selecting one or more network targets for hosting the complete web system. The method 1400 includes, at step 1404, deploying the plurality of components for the complete web system using the set of infrastructure code such that the plurality of components is automatically configured and integrated to form the complete web system on the one or more network targets.

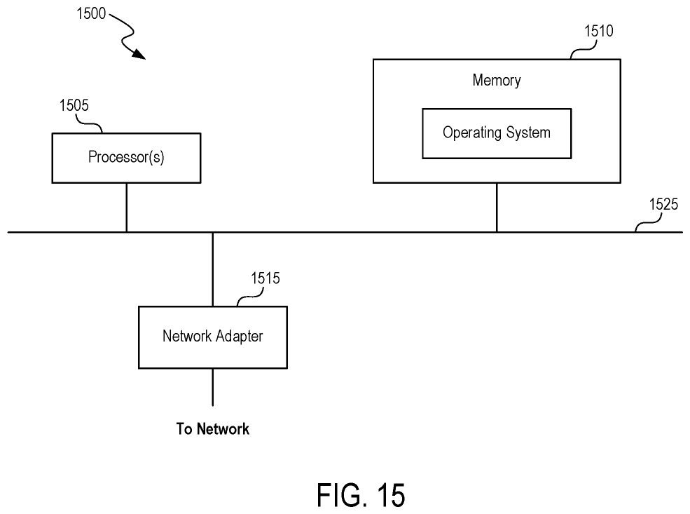

FIG. 15 is a block diagram illustrating an example of the architecture for a computer system or other control device 1500 that can be utilized to implement various portions of the presently disclosed technology. In FIG. 15, the computer system 1500 includes one or more processors 1505 and memory 1510 connected via an interconnect 1525. The interconnect 1525 may represent any one or more separate physical buses, point to point connections, or both, connected by appropriate bridges, adapters, or controllers. The interconnect 1525, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire.”

The processor(s) 1505 may include central processing units (CPUs) to control the overall operation of, for example, the host computer. In certain embodiments, the processor(s) 1505 accomplish this by executing software or firmware stored in memory 1510. The processor(s) 1505 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1510 can be or include the main memory of the computer system. The memory 1510 represents any suitable form of random access memory (RAM), read-only memory (ROM), flash memory, or the like, or a combination of such devices. In use, the memory 1510 may contain, among other things, a set of machine instructions which, when executed by processor 1505, causes the processor 1505 to perform operations to implement embodiments of the presently disclosed technology.

Also connected to the processor(s) 1505 through the interconnect 1525 is a (optional) network adapter 1515. The network adapter 1515 provides the computer system 1500 with the ability to communicate with remote devices, such as the storage clients, and/or other storage servers, and may be, for example, an Ethernet adapter or Fiber Channel adapter.

It is thus evident that this patent document describes techniques provided by Agile Stacks that allow the user to deploy components of a SuperStack to multiple environments across cloud. Because SuperHub has the capability to test combinations of components when new versions or patches to a component become available, the system can ensure the pre-built SuperHub stack templates will deploy and work properly with minimal efforts from customers.

In Agile Stacks, the automated infrastructure provided in the form of code generation takes into account usage data by the users to allow the deployed SuperStacks to run at lower costs, higher reliability, and better performance. The ability to create SuperSuperHub stack templates automatically and consistently using Agile Stacks provides organizations with repeatable deployment, certification, and auditing capabilities that are previously difficult or impossible to obtain. Agile Stacks dramatically increases agility in many ways for its customers to allow the customers to advance into the market faster and provide more frequent updates.

For sophisticated customers, Agile Stacks also provides flexible programming interfaces that allow developers to modify and change SuperStack configurations based on the automatically generated code. The SuperHub makes it easier for companies to change their reference architectures by replacing one component with another, or to change their cloud providers.

In one example aspect, a system for managing data center and cloud application infrastructure includes a user interface configured to allow a user to select a plurality of components from a pool of available components. Each of the components provides one or more infrastructure capabilities for integration into a complete application infrastructure environment that includes at least network, data storage, and business logic capabilities. The system includes a management platform in communication with the user interface. The management platform is configured to (1) create a template based on the plurality of components, and (2) generate a set of infrastructure code based on the template to allow automatic configuration of the plurality of components and integration of the plurality of components into the complete web system. The template includes a set of files describing the plurality of components and corresponding integration parameters of the plurality of components for the complete web system. The user interface is further configured to allow the user to deploy the plurality of components for the complete web system using the set of infrastructure code such that the plurality of components is automatically configured and integrated to form the complete web system on one or more network targets.

In some embodiments, the system includes a test engine configured to test combinations of the components from the pool of available components and generate a result matrix indicating a compatibility success or a compatibility failure for each of the combinations. In some embodiments, the user interface is configured to prevent the user from selecting a component from the pool of available components upon determining, based on the result matrix, that the component is incompatible with one or more previously selected components. In some embodiments, the management platform is configured to receive usage data after the complete web system is deployed on the one or more network targets.

In some embodiments, the set of infrastructure code includes one or more indicators for indicating one or more usage areas to correlate the usage data with each of the one or more usage areas. In some embodiments, the system includes a database configured to store the usage data in an anonymized manner for users of the system. In some embodiments, the management platform is further configured to generate the set of infrastructure code based on the usage data to allow the automatic configuration of the plurality of components to be tailored to a usage pattern indicated by the usage data. In some embodiments, the usage data includes at least one of: central processing unit (CPU) usage, memory usage, network usage, or service cost.

In another example aspect, a method for managing data center and cloud application infrastructure by a computer includes selecting a plurality of components from a pool of available components. Each of the components provides one or more infrastructure capabilities for integration into a complete application infrastructure environment that includes at least network, data storage, and business logic capabilities. The method includes operating a management platform to generate (1) a template based on the plurality of components, and (2) a set of infrastructure code based on the template to allow automatic configuration of the plurality of components and integration of the plurality of components into the complete web system. The template includes a set of files describing the plurality of components and corresponding integration parameters of the plurality of components for the complete web system. The method includes selecting one or more network targets for hosting the complete web system. The method also includes deploying the plurality of components for the complete web system using the set of infrastructure code such that the plurality of components is automatically configured and integrated to form the complete web system on the one or more network targets.

In some embodiments, the selecting of the plurality of components includes selecting a first component from the pool of available components and selecting a second component from a subset of components in the pool of available components. The subset of components is adjusted based on the first component and a result matrix that indicates compatibility of the first component and other components in the pool of available components.

In some embodiments, the method includes operating the management platform to receive usage data after the complete web system is deployed on the one or more network targets. In some embodiments, the method includes adding one or more indicators for indicating one or more usage areas such that the usage data is correlated with each of the one or more usage areas. In some embodiments, the method includes adjusting the set of infrastructure code based on the usage data to allow the automatic configuration of the plurality of components to be tailored to a usage pattern indicated by the usage data. In some embodiments, the usage data includes at least one of: central processing unit (CPU) usage, memory usage, network usage, or service cost.

In another example aspect, a non-volatile, non-transitory computer readable medium having code stored thereon is disclosed. The code, when executed by a processor, causes the processor to implement a method that comprises providing a user interface to allow a user to select a plurality of components from a pool of available components. Each of the components provides one or more infrastructure capabilities for integration into a complete application infrastructure environment that includes at least network, data storage, and business logic capabilities. The method includes creating a template based on the plurality of components. The template includes a set of files describing the plurality of components and corresponding integration parameters of the plurality of components for the complete web system. The method includes generating a set of infrastructure code based on the template to allow automatic configuration of the plurality of components and integration of the plurality of components into the complete web system. The user interface is configured to allow the user to deploy the plurality of components for the complete web system using the set of infrastructure code such that the plurality of components is automatically configured and integrated to form the complete web system on one or more network targets.

In some embodiments, the method includes testing combinations of the components from the pool of available components and generating a result matrix indicating a compatibility success or a compatibility failure for each of the combinations. In some embodiments, the user interface is configured to prevent the user from selecting a component from the pool of available components upon determining, based on the result matrix, that the component is incompatible with one or more previously selected components.

In some embodiments, the method includes receiving usage data after the complete web system is deployed on the one or more network targets. In some embodiments, the set of infrastructure code includes one or more indicators for indicating one or more usage areas to correlate the usage data with each of the one or more usage areas. In some embodiments, the method includes storing the usage data in a database in an anonymized manner for users of the system. In some embodiments, the method includes generating the set of infrastructure code based on the usage data to allow the automatic configuration of the plurality of components to be tailored to a usage pattern indicated by the usage data. In some embodiments, the usage data includes at least one of: central processing unit (CPU) usage, memory usage, network usage, or service cost. In some embodiments, the user interface is further configured to allow a comparison of multiple templates for determining changes in the templates or performing analysis on the multiple templates created by a user.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A system for managing data center and cloud application infrastructure, comprising:
a user interface configured to allow a user to select a plurality of components from a pool of available components, each of the components providing one or more infrastructure capabilities for integration into a complete application infrastructure environment that includes at least network, data storage, and business logic capabilities; and
a management platform in communication with the user interface, wherein the management platform is configured to (1) create a template based on the plurality of components, wherein the template includes a set of files describing the plurality of components and corresponding integration parameters of the plurality of components for the complete web system, and (2) generate a set of infrastructure code based on the template to allow automatic configuration of the plurality of components and integration of the plurality of components into the complete web system,
wherein the user interface is further configured to allow the user to deploy the plurality of components for the complete web system using the set of infrastructure code such that the plurality of components is automatically configured and integrated to form the complete web system on one or more network targets.

2. The system of claim 1, further comprising:
a test engine configured to test combinations of the components from the pool of available components and generate a result matrix indicating a compatibility success or a compatibility failure for each of the combinations.

3. The system of claim 2, wherein the user interface is configured to prevent the user from selecting a component from the pool of available components upon determining, based on the result matrix, that the component is incompatible with one or more previously selected components.

4. The system of claim 1, wherein the management platform is configured to receive usage data after the complete web system is deployed on the one or more network targets.

5. The system of claim 4, wherein the set of infrastructure code includes one or more indicators for indicating one or more usage areas to correlate the usage data with each of the one or more usage areas.

6. The system of claim 4, further comprising:
a database configured to store the usage data in an anonymized manner for users of the system.

7. The system of claim 5, wherein the management platform is further configured to generate the set of infrastructure code based on the usage data to allow the automatic configuration of the plurality of components to be tailored to a usage pattern indicated by the usage data.

8. The system of claim 5, wherein the usage data includes at least one of: central processing unit (CPU) usage, memory usage, network usage, or service cost.

9. A method for managing data center and cloud application infrastructure by a computer, comprising:
selecting a plurality of components from a pool of available components, wherein each of the components provides one or more infrastructure capabilities for integration into a complete application infrastructure environment that includes at least network, data storage, and business logic capabilities;
operating a management platform to generate (1) a template based on the plurality of components, wherein the template includes a set of files describing the plurality of components and corresponding integration parameters of the plurality of components for the complete web system, and (2) a set of infrastructure code based on the template to allow automatic configuration of the plurality of components and integration of the plurality of components into the complete web system;
selecting one or more network targets for hosting the complete web system; and
deploying the plurality of components for the complete web system using the set of infrastructure code such that the plurality of components is automatically configured and integrated to form the complete web system on the one or more network targets.

10. The method of claim 9, wherein the selecting of the plurality of components comprises:
selecting a first component from the pool of available components, and
selecting a second component from a subset of components in the pool of available components, wherein the subset of components is adjusted based on the first component and a result matrix that indicates compatibility of the first component and other components in the pool of available components.

11. The method of claim 9, further comprising:
operating the management platform to receive usage data after the complete web system is deployed on the one or more network targets.

12. The method of claim 11, further comprising:
adding one or more indicators for indicating one or more usage areas such that the usage data is correlated with each of the one or more usage areas.

13. The method of claim 11, further comprising:
adjusting the set of infrastructure code based on the usage data to allow the automatic configuration of the plurality of components to be tailored to a usage pattern indicated by the usage data.

14. The method of claim 11, wherein the usage data includes at least one of: central processing unit (CPU) usage, memory usage, network usage, or service cost.

15. A non-volatile, non-transitory computer readable medium having code stored thereon and when executed by a processor causing the processor to implement a method that comprises:
providing a user interface to allow a user to select a plurality of components from a pool of available components, each of the components providing one or more infrastructure capabilities for integration into a complete application infrastructure environment that includes at least network, data storage, and business logic capabilities;
creating a template based on the plurality of components, wherein the template includes a set of files describing the plurality of components and corresponding integration parameters of the plurality of components for the complete web system;
generating a set of infrastructure code based on the template to allow automatic configuration of the plurality of components and integration of the plurality of components into the complete web system, wherein
the user interface is configured to allow the user to deploy the plurality of components for the complete web system using the set of infrastructure code such that the plurality of components is automatically configured and integrated to form the complete web system on one or more network targets.

16. The non-transitory computer readable medium of claim 15, wherein the method further comprises:
testing combinations of the components from the pool of available components, and
generating a result matrix indicating a compatibility success or a compatibility failure for each of the combinations.

17. The non-transitory computer readable medium of claim 15, wherein the user interface is configured to prevent the user from selecting a component from the pool of available components upon determining, based on the result matrix, that the component is incompatible with one or more previously selected components, and
wherein the set of infrastructure code includes one or more indicators for indicating one or more usage areas to correlate the usage data with each of the one or more usage areas.

18. The non-transitory computer readable medium of claim 15, wherein the method further comprises: further comprising:
receiving usage data after the complete web system is deployed on the one or more network targets.

19. (canceled)

20. The non-transitory computer readable medium of claim 18, wherein the method comprises:
storing the usage data in a database in an anonymized manner for users of the system.

21. The non-transitory computer readable medium of claim 18, wherein the method further comprises:
generating the set of infrastructure code based on the usage data to allow the automatic configuration of the plurality of components to be tailored to a usage pattern indicated by the usage data.

22. (canceled)

23. (canceled)
